(19) United States
(12) Patent Application Publication
(10) Pub. No.: US 2017/0007868 A1
(43) Pub. Date: Jan. 12, 2017

(54) System and Method for Containing Water from a Broken Fire Sprinkler

(71) Applicant: Oscar Aguilar, Houston, TX (US)

(72) Inventor: Oscar Aguilar, Houston, TX (US)

(21) Appl. No.: 14/792,620

(22) Filed: Jul. 7, 2015

(51) Int. Cl. A62C 35/68; F16L 21/06; F16L 33/32

(52) U.S. Cl. CPC A62C 35/68; F16L 33/32; F16L 21/06

(57) ABSTRACT

This disclosure teaches a system and method for containing water from a broken fire sprinkler. A fire sprinkler stopper device can comprise one or more pipes, a connector, a collapsible hose, and a valve. The connector can be connected to first end portion of the pipe. The other end of the connector can be mateable with a sprinkler head. The collapsible hose can be attached at the outer surface of first end portion of the pipes. The other end portion of the pipes can be attached to the valve.

### BACKGROUND

This disclosure relates to a system and method for containing water from a broken fire sprinkler.

Fire sprinklers are extensively used worldwide as a fire protection measure. Historically, fire sprinkler systems are commonly used in large commercial buildings and factories. Today, fire sprinklers are made available for home, office spaces, and small buildings at a cost effective price. For decades, fire sprinklers have saved lives and minimized damaged to properties effectively. However, fire sprinklers just like any other mechanical device can become damaged and broken. When a fire sprinkler is accidentally broken it can cause discharge of water in a common spray pattern, which can be very hard to contain in an instant. Thus, depending on the range can release water all over the area. The best way to control the water is through turning off the main water valve. However, in commercial or office areas locating the main water valve can take time or would require authorized personnel to have it turned off. Thus, broken fire sprinkler can cause damage to property, flooded vicinity, and/or wasted working hours if such incident is not taken care off immediately. As such it would be useful to have an improved system and method for containing water from a broken fire sprinkler.

### SUMMARY

This disclosure teaches a system and method for containing water from a broken fire sprinkler. A fire sprinkler stopper device can comprise one or more pipes, a connector, a collapsible hose, and a valve. The connector can be connected to first end portion of the pipe. The other end of the connector can be mateable with a sprinkler head. The collapsible hose can be attached at the outer surface of first end portion of the pipes. The other end portion of the pipes can be attached to the valve.

This disclosure also teaches a method of containing water from a sprinkler. The method can comprise the step of pushing top end portion of a stopper device to the sprinkler. The stopper device can comprise one or more pipes, a connector, a collapsible hose, and a valve. The connector can be connected to first end portion of the pipe. The other end of the connector can be mateable with a sprinkler head. The collapsible hose can be attached at the outer surface of first end portion of the pipes. The other end portion of the pipes can be attached to the valve.

### BRIEF DESCRIPTION OF THE DRAWINGS

FIG. 1 illustrates a stopper device being connected to a sprinkler head.

FIG. 2 illustrates an exploded view of a stopper device.

FIG. 3 illustrates a connector comprising rubber inserts.

FIG. 4A illustrates a sectional view of the top end portion of pipes.

FIG. 4B illustrates a sectional view of the top end portion of pipes attached to a sprinkler system.

FIG. 5A illustrates a sectional view of a valve at an open state

FIG. 5B illustrates a sectional view of a valve at a closed state.

FIG. 6 illustrates how a stopper device can be used to contain flow of water.

### DETAILED DESCRIPTION

Described herein is a system and method for containing water from a broken fire sprinkler. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

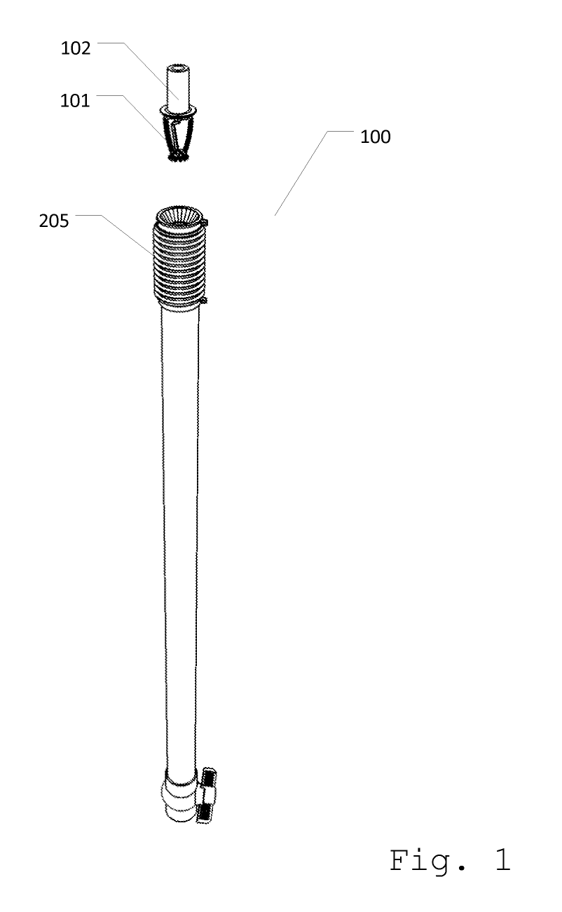

FIG. 1 illustrates a stopper device 100 being connected to a sprinkler head 101. Sprinkler head 101 can be a part of a fire sprinkler system that discharges water when heat or fire has been detected. Furthermore sprinkler head 101 can vary in types, sizes, and shapes that can include but are not limited to conventional, pendent, recessed pendent, horizontal sidewall, or vertical sidewall. Moreover, sprinkler head 101 can be attached to a water pipe 102 that provides water supply to the sprinkler system. Stopper device 100 can be used to allow flow of water from sprinkler head 101 be controlled or contained. Moreover, stopper device 100 can prevent the water from spraying all over the area.

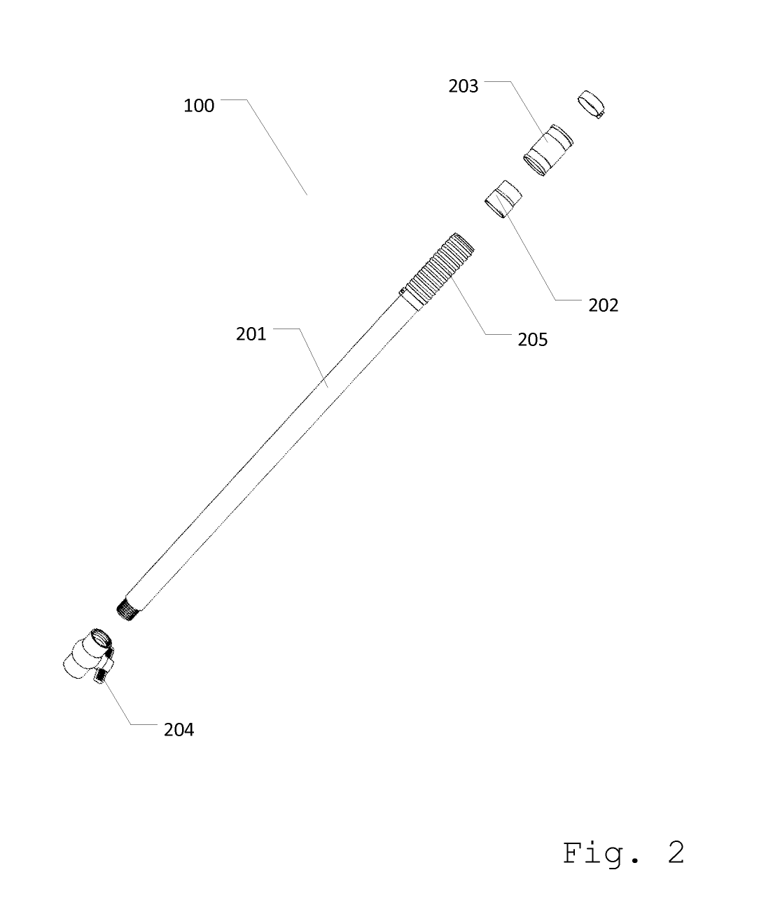

FIG. 2 illustrates an exploded view of stopper device 100. Stopper device 100 can comprise one or more pipes 201, one or more fittings 202, a connector 203, a valve 204, and a hose 205. Pipes 201 can be a hollow cylindrical tube made of durable material such as metal, fiber glass, or plastic. Pipes 201 can be used to allow the flow of water. Furthermore, pipes 201 can comprise a threaded end at both ends. Thus, pipes 201 can be mateable at both ends. As such, each ends of fitting 202 can comprise a threaded end that is compatible with the threaded ends of pipes 201. Moreover, fitting 202 can have various shapes, which include but are not limited to elbow union, and straight union. As such, fitting 202 can be used to attach first end of pipes 201 with connector 203, in one embodiment. Additionally, fitting 202 can be used to change direction of water within pipes 201. Further, the second end portion of pipes 201 can be attached to valve 204. As such, valve 204 can also comprise of threaded ends that is compatible with the threaded ends of pipes 201. Further, connector 203 can be used to affix a sprinkler head 101 with stopper device 100. As such, connector 203 can be configured mateable with the sprinkler head 101. In another embodiment, connector 203 can be directly connected to first end portion of pipes 201. In these embodiments, connector 203 can be detachable from pipes 201. Thus, connector 203 can be replaceable. As such, when connector 203 is damage, a second connector 203 can be used to replace the damaged connector. Further in another embodiment, first end of pipe 201 can be configured as connector 203 to sprinkler head 101. In such embodiment, first end of pipe 201 and connector 203 can be considered a single device. Furthermore in this embodiment, connector 203 can be permanently attached to first end portion of pipe 201. Further, connector 203 and one end of valve 204 can be used to direct and regulate the flow of water within pipes 201. Valve 204 can be made of durable material such as metal or plastics. As such, valve 204 can be maneuverable into an open position and a closed position. Further, stopper device 100 can use any type of valve 204, which includes but are not limited to ball valve, gate valve, butterfly valve, or globe valve. Hose 205 can be a collapsible hose attached at the outer surface of first end portion of pipes 201, which can cover the top end portion of pipe 201. Furthermore, hose 205 when stretched upward can cover the outer portion of connector 203.

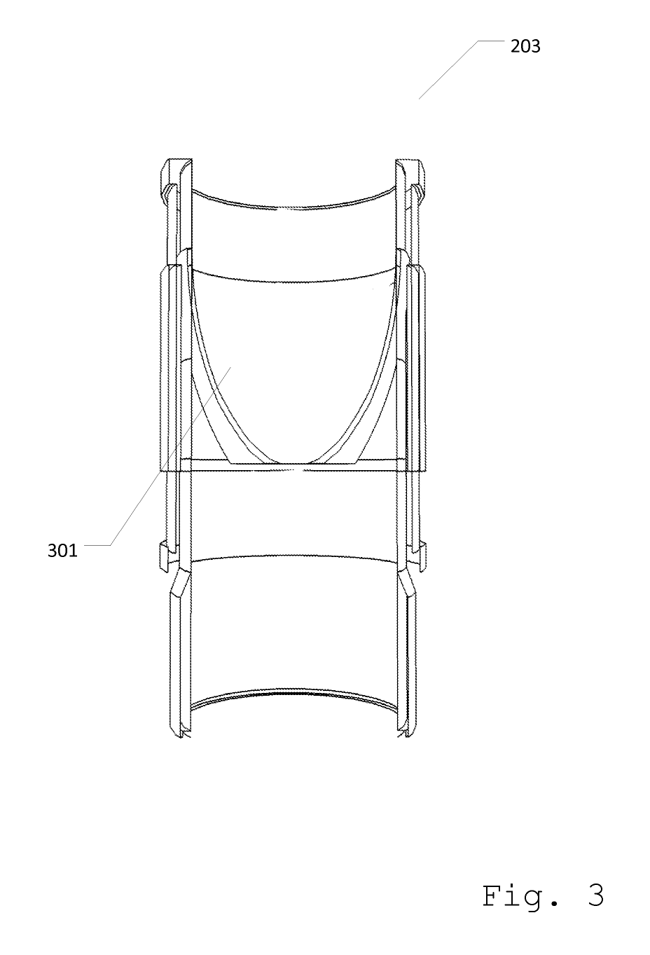

FIG. 3 illustrates connector 203 comprising rubber inserts 301. Since sprinkler head 101 can vary in dimensions, connector 203 can be made of flexible material to allow connector 203 compatible with different kinds of sprinkler head 101. As such, connector 203 can comprise natural or synthetic elastomers and fabrics. Moreover, connector 203 can be configured reusable and easier to install. Rubber inserts 301 can be placed within the inner orifice of connector 203. Rubber inserts 301 can comprise a hole 302. Hole 302 can be the inner diameter of rubber inserts 301 insertable by sprinkler head 101. Further, rubber inserts 301 can be configured to taper inwardly. This structure can allow rubber inserts 301 to be wrapped around sprinkler head 101 firmly. In one embodiment, holes 302 of rubber inserts 301 can be threaded. This can allow connector 203 to be securely attached to sprinkler head 101.

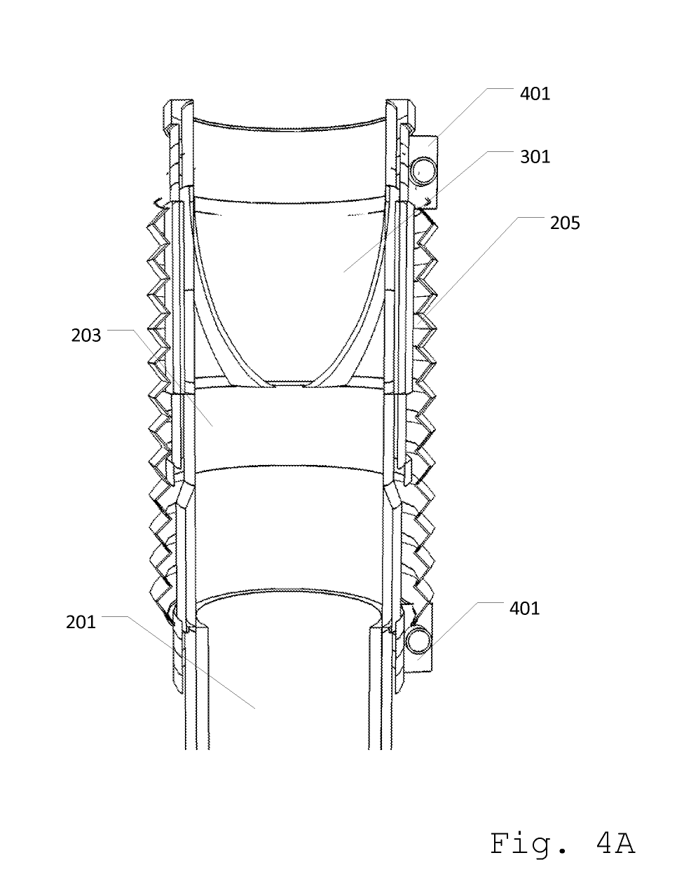

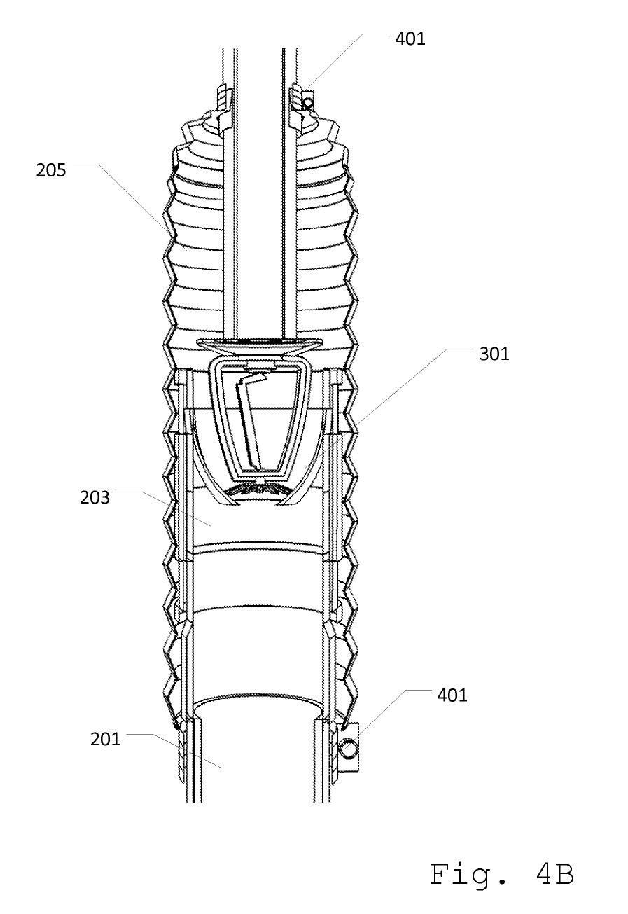

FIG. 4A illustrates a sectional view of the top end portion of pipe 201. The bottom end portion of hose 205 can be attached near the top end portion of pipe 201. In one embodiment, bottom end portion of hose 205 can be permanently fixed at the outer surface of pipe 201. In such embodiment, bottom end portion of hose 205 can be attached to pipe 201 through use of any adhesives. In another embodiment, hose 205 can be attached through fasteners 401 such as a clamp. The top end portion of hose 205 can be loosely fastened at the top end portion of pipe 201. This can allow top portion of hose 205 to easily be extended upward.

FIG. 4B illustrates a sectional view of the top end portion of pipe 201 attached to a sprinkler system. When stopper device 100 is in use, top end portion of pipe 201 can be pushed towards sprinkler head 101. In such scenario, sprinkler head 101 can be inserted within holes 302 of rubber inserts 301. As such, top end portion of pipe 201 can be securely attached to the sprinkler system. Once stopper device 100 is in place, hose 205 can be extended upward to enclose sprinkler head 101. As such the top end portion of hose 205 can be fastened tightly around water pipe 102 through fastener 401. In this state, when the pressure of the water from the sprinkler system pushes rubber inserts 301, hose 205 can still be attached to water pipe 201 that can prevent the water from spraying all over the place.

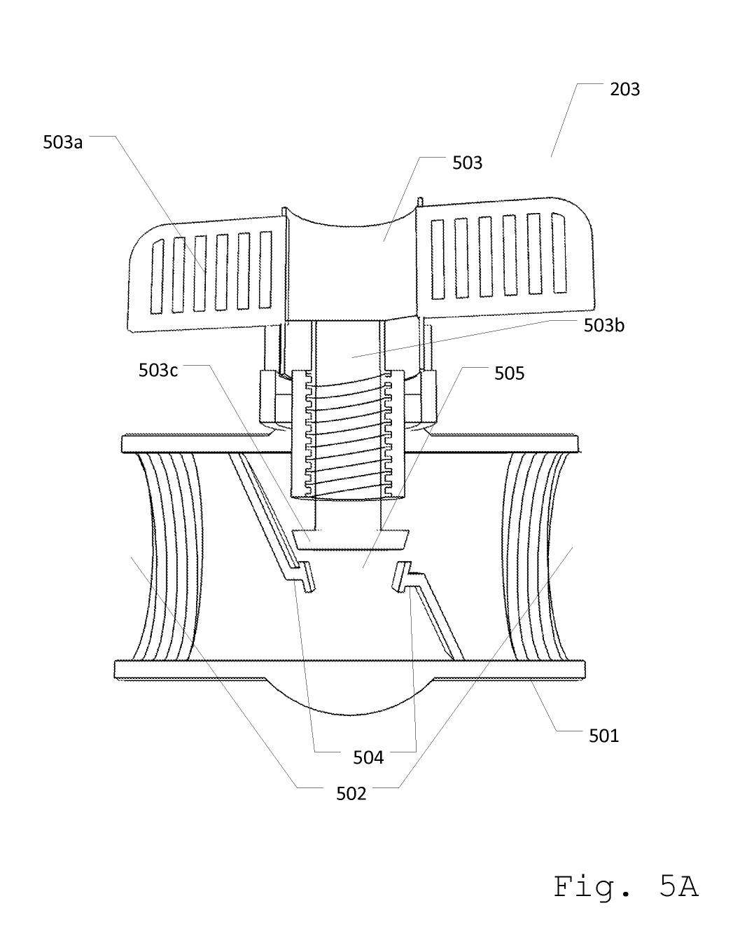

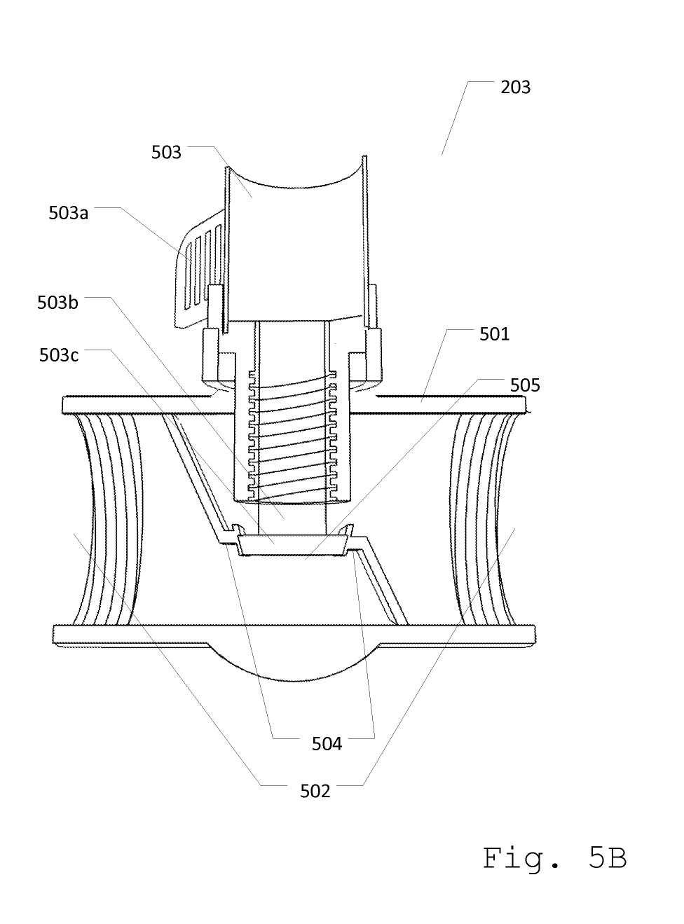

FIG. 5A illustrates a sectional view of valve 204 at an open state. For purposes of this disclosure, globe water valve is illustrated and discussed. However such discussion of valve type is solely exemplary, and not limiting. This type of valve 204 can be used to limit the flow of water. Further, valve 204 can comprise mainly of a body 501, a pair of ports 502, and a plug 503. Body 501 can be the casing that holds the water flowing within valve 204. The inner surface of body 501 can comprise a seat 504. Seat 504 can be a protruding surface within body 401 thus creating a crevice 505 at the inner surface of body 501. Ports 502 can be placed at the outer ends of body 501. Ports 502 can be the openings on valve 204 that allows passage of water. As such ports 502 can comprise an inner port 502a and an outer port 502b. Threaded end portion of inner port 502a can be connected to the threaded end of pipes 201. This can allow water from pipes 201 to pass through inner port 502a and flow out through outer port 502b. Plug 503 can be used to allow and stop the flow of water from pipe 201. Plug 503 can comprise a handle 503a, a stem 503b, and a disc 503c. Handle 503a can act as an actuator that is used to manually control the flow of water within body 501. Handle 503a can be mounted at the top surface of body 501. While, the bottom portion of plug 503 which comprises stem 503b and disc 503c can be mounted within the inner surface of body 501. Stem 503b can transmit the motion made from handle 503a to disc 503c. As such, top end of stem 503b can be connected to handle 503a while the bottom end can be connected to disc 503c. The middle section of stem 503b can comprise a threaded portion. The threaded portion of stem 503b can be mateable within the inner portion of body 501. This can allow stem 503b to be screwed into or out of valve 204. Stem 503b can either utilize a linear force or a rotational force, which can maneuver disc 503c to move closer or farther from seat 504. Disc 503c can be used to block or permit water from passing through valve 204. As such, disc 503c can be configured to rest on top of seat 504 to tightly seal crevice 505.

In an open state, handle 503a can be actuated to move plug 503 away from seat 504 therefore opening crevice 505. As such, the water coming from fire sprinkler 101 can continuously flow from pipe 201 through valve 204. In such state, disc 503c can be positioned away from seat 504. This leaves crevice 505 unblocked therefore, allowing water to flow out through outer port 502b. Moreover, handle 503a can be actuated to move plug 503 closer to seat 504 leaving a smaller opening for crevice 505. As such, water passing through ports 502 can be controlled and limited.

FIG. 5B illustrates a sectional view of valve 204 at a closed state. At this state, handle 503a can be actuated to move disc 503c resting at seat 504. As such, disc 503c can fully block crevice 505 preventing the water from flowing out of outer port 502b.

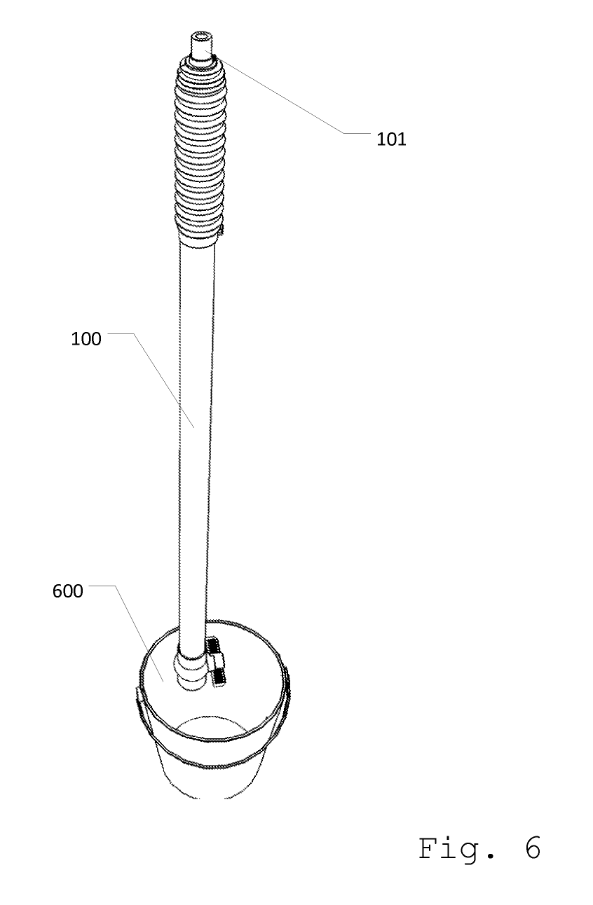

FIG. 6 illustrates how stopper device 100 can be used to contain flow of water. In an event wherein a fire sprinkler system is broken causing sprinkler head 101 to discharge water, stopper device 100 can be used to contain or direct water to prevent damage to properties or even flooding. As such, connector 203 can be firmly attached to sprinkler head 101 in order to prevent the water from spraying water on the area. Thus water coming from sprinkler head 101 can flow within pipes 201 and be directed towards valve 204. In the event wherein pressure is to much and rubber inserts 301 is pushed out from sprinkler head 101, hose 205 that is attached to water pipe 102 can provide an additional protection to contain the water. Further valve 204 can be set on a close state while outer port 502b has not been directed to a container 500 or connected to a hose. Once container 500 or hose is in place, valve 204 can be adjusted to limit the flow of water or to be open fully to discharge water completely. Such scenario can allow personnel in the area to direct the water to a drainage system. As such, giving enough time until maintenance or repair personnel can control the situation.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A fire sprinkler stopper device comprising
one or more pipes;
a connector, said connector connected to first end portion of said pipes, further wherein other end of said connector mateable with a sprinkler head;
a collapsible hose attached at the outer surface of first end portion of said pipes; and
a valve, wherein the other end portion of said pipe attached to said valve.

2. The system of claim 1 wherein the inner orifice of said connector comprises rubber inserts.

3. The system of claim 2 wherein the inner diameter of said rubber inserts is threaded.

4. The system of claim 1 wherein first end portion of said pipes is permanently attached to said connector.

5. The system of claim 1 wherein first end portion of said pipes is detachable from said connector.

6. The system of claim 5 wherein said connector is replaceable.

7. The system of claim 1 wherein said pipes connected together through one or more fittings.

8. The system of claim 7 wherein said fittings used to change direction of water within said pipes.

9. The system of claim 1 wherein the bottom end portion of said collapsible hose is permanently attached near the top end portion of said pipes.

10. The system of claim 1 wherein the top end portion of said collapsible hose is loosely fastened at the top end portion of said pipes through a fastener.

11. The system of claim 10 wherein said fastener is a clamp.

12. A method of containing water from a sprinkler comprising
pushing top end portion of a stopper device to said sprinkler, said stopper device comprising
one or more pipes;
a connector, said connector connected to first end portion of said pipes, further wherein other end of said connector mateable with a sprinkler head;
a collapsible hose attached at the outer surface of first end portion of said pipes; and
a valve, wherein the other end portion of said pipe attached to said valve.

13. The method of claim 12 further comprising the step of extending said collapsible hose upward enclosing said sprinkler head.

14. The method of claim 13 further comprising the step of fastening top end portion of said collapsible hose around a water pipe of said sprinkler head.

15. The method of claim 12 further comprising the step of opening said valve to allow passage of water.
